(19) United States
(12) Patent Application Publication
(10) Pub. No.: US 2013/0314406 A1
(43) Pub. Date: Nov. 28, 2013

(54) METHOD FOR CREATING A NAKED-EYE 3D EFFECT

(71) Applicant: National Taiwan University, Taipei (TW)

(72) Inventor: CHING-FUH LIN, Taipei (TW)

(73) Assignee: National Taiwan University, Taipei (TW)

(21) Appl. No.: 13/900,760

(22) Filed: May 23, 2013

(30) Foreign Application Priority Data
May 23, 2012 (TW) 101118435

(51) Int. Cl. G06T 11/00

(52) U.S. Cl. CPC G06T 11/00
USPC 345/419

(57) ABSTRACT

The present invention relates to a method for creating a naked-eye effect, and particularly relates to a method for creating a naked-eye effect without requiring a display hologram, special optical film, or 3D glasses. This method includes following steps: (1) detecting rotating angle or moving position of a portable device by a detecting unit; (2) creating a new image of an object shown in a display according to the rotating angle or moving position of the portable device by an image processing unit; and (3) displaying the new image of the object in the display instead of the original image of the object. By this method, a different image of the same object with different visual angles is displayed at different times, and it lets the brain of a person consider that the image of the object is a 3D image. Therefore, a naked-eye effect can be created.

### CROSS-REFERENCE TO RELATED APPLICATIONS

The entire contents of Taiwan Patent Application No. 101118435, filed on May 23, 2012, from which this application claims priority, are incorporated herein by reference.

### BACKGROUND OF THE INVENTION

1. Field of the Invention

The present invention relates to a method for creating a naked-eye effect, and particularly relates to a method for creating a naked-eye effect without requiring a display hologram, special optical film, and 3D glasses.

2. Description of Related Art

With increasing requirements for enhanced visual effects, 3D visual effects are being applied to various electronic products gradually and widely, such as mobile phone, PDA, laptop (or notebook PC), flat panel display, etc. The common 3D technologies are the (display) hologram and the left-eye image and right-eye image superimposition. Fabrication of the display hologram often involves complex optical computing and the display hologram provides a 3D image by light interference. It makes the fabrication of the display hologram more complicated and difficult. Therefore, it results in high cost and long processing time of the fabrication of the display hologram and difficulty in fabrication of the display hologram. Accordingly, the left-eye image and right-eye image superimposition (technology) is a 3D image technology which is more widely used than the (display) hologram.

Generally, left-eye image and right-eye image superimposition (technology) is classified into two categories: one is to provide a 3D image through 3D glasses, and another is to provide a 3D image through a special optical film. For performing the left-eye image and right-eye image superimposition (technology), a display is utilized to simultaneously show a left-eye image and a right-eye image in its screen, and the user wears the 3D glasses or the special optical film is formed on the screen. Therefore, the left-eye image is only transmitted to the left eye of the user and only received by the left eye of the user for projecting on the retina of the user, and the right-eye image is only transmitted to the right eye of the user and only received by the right eye of the user for projecting on the retina of the user. In fact, the left-eye image and the right-eye image projected on the retina of the user are still 2D images. However, the brain of the user will automatically superimpose the left-eye image and the right-eye image projected on the retina of the user, and the brain of the user will adjust the focus points of the left eye and the right eye to be the same for creating a 3D image. In fact, the left-eye image and the right-eye image projected on the retina of the user are still 2D images, but through parallax adjustment of the left eye and the right eye of the user caused by the brain of the user, a fictitious 3D image is created and a 3D image effect can be achieved.

However, it is heavy, cumbersome, and inconvenient for the user to wear the 3D glasses, and particularly, it is very inconvenient for the user wearing glasses for the myopia to wear the 3D glasses. Although the method of providing a 3D image with the special optical film coated on the screen of the display has no need for the 3D glasses, the special optical film is difficult to be fabricated. Moreover, the distance between the left eye and the right eye varies from person to person, so this method cannot provide the same 3D effect for different persons. Therefore, there is a need for a method of creating or providing a 3D image to the user without a display hologram, 3D glasses, and a special optical film coated on a screen of a display.

### SUMMARY OF THE INVENTION

In view of the foregoing, one object of the present invention is to provide a method for creating a naked-eye 3D effect. This method can be applied to a portable device, such as mobile phone, PDA, Tablet PC, and satellite navigating equipment, for providing a 3D image to a user without a display hologram, 3D glasses, and a special optical film coated on a screen of a display.

Another object of the present invention is to provide a method for creating a naked-eye 3D effect. By this method, a user can see a 3D image directly through his eyes without using the elements which is inconvenient to be used or difficult to be fabricated, such as the display hologram, the 3D glasses, and the special optical film coated on a screen of a display. Therefore, the cost and the difficulty for providing a 3D image to the user and for creating a 3D naked-eye effect is decreasing.

According to one object of the present invention, a method for creating a naked-eye 3D effect is disclosed herein and this method is applied to a portable device. The method comprises following steps: (1) detecting a rotating angle or a moving position of a portable device by a detecting unit; (2) processing an image of an object shown in a screen of a display by an image processing unit according to the rotating angle or the moving position of the portable device, and then creating a rotating or moving image of the object shown in the display by the image processing unit according to the rotating angle or the moving position of the portable device; and (3) displaying the rotating or moving image of the object in the screen of the display instead of the original image of the object shown in the display for showing images of the object shown in the display with different view angles (or visual angles). By showing the images of the same object with different view angles (or visual angles) corresponding to the rotation and movement of the portable device at different times, the 2D image of the object shown in the screen of the display varies with time. Therefore, the brain of the user automatically compares the images of the same object shown at different times through memory, and then the brain of the user will spontaneously consider that the image of the object shown in the screen of the display is a 3D image whereby a naked-eye effect can be achieved.

According to another object of the present invention, a method for creating a naked-eye 3D effect is disclosed herein. The method comprises following steps: (1) detecting a moving position and a moving distance of a user or a moving position and a moving distance of eyeballs of a user by a detecting unit; (2) processing an image of an object shown in a screen of a display by an image processing unit according to the moving position and the moving distance of the user or the moving position and the moving distance of the eyeballs of the user, and then creating a rotating or moving image of the object shown in the screen of the display by the image processing unit according to the moving position and the moving distance of the user or the moving position and the moving distance of the eyeballs of the user; and (3) displaying the rotating or moving image of the object in the screen of the display instead of the original image of the object shown in the display for showing images of the object shown in the display with different view angles (or visual angles). By showing the images of the same object with different view angles (or visual angles) corresponding to the rotation and movement of the portable device at different times, the 2D image of the object shown in the screen of the display varies with time. Therefore, the brain of the user automatically compares the images of the same object shown at different times through memory, and then the brain of the user will spontaneously consider that the image of the object shown in the screen of the display is a 3D image and a naked-eye effect can be achieved.

Therefore, the present invention provides a method for creating a naked-eye 3D effect. This method utilizes time as the longitudinal axis. In this method, the brain of the user will spontaneously consider that the image of the object shown in the screen of the display is a 3D image because the brain of the user automatically compares the images of the same object shown at different times to find the differences between these images shown at different times. Therefore, the naked-eye 3D effect is created or provided by this method without a display hologram, 3D glasses, and a special optical film coated on a screen of a display. Furthermore, the cost and the difficulty for providing a 3D image to the user and for creating a 3D naked-eye effect is decreasing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flowchart illustrating a method for creating a naked-eye 3D effect in accordance with an embodiment of the present invention.

FIG. 2 is a drawing illustrating a method for creating a naked-eye 3D effect with a mobile phone having a detecting unit, an image processing unit, and a display integrated therein in accordance with an embodiment of the present invention.

FIG. 3A to FIG. 3C are drawings respectively illustrating the images of the same object shown in the mobile phone with different view angles (or visual angles) corresponding to different rotating angles in accordance with an embodiment of the present invention.

FIG. 4 is a flowchart illustrating a method for creating a naked-eye 3D effect in accordance with another embodiment of the present invention.

FIG. 5 is a drawing illustrating a method for creating a naked-eye 3D effect with a system consisting of a flat panel display and a detecting unit in accordance with an embodiment of the present invention.

FIG. 6A to FIG. 6C are drawings respectively illustrating the images of the same object shown in the flat panel display with different view angles (or visual angles) corresponding to different moving positions and different moving distances of a user or different moving positions and different moving distances of eyeballs of a user in accordance with an embodiment of the present invention.

FIG. 7 is a drawing illustrating a method for creating a naked-eye 3D effect with a detecting unit worn by a user in accordance with an embodiment of the present invention.

### DETAILED DESCRIPTION OF THE PREFERRED EMBODIMENT

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components. Although specific embodiments have been illustrated and described, it will be appreciated by those skilled in the art that various modifications may be made without departing from the scope of the present invention, which is intended to be limited solely by the appended claims.

This world is a 4D world. It means that the world contains axes of (X, Y, Z, t). (X, Y, Z) represent space, and (t) represents time. Therefore, so-called 3D is a projection of 4D. In fact, the 3D in brains of humans is not (X, Y, Z). The 3D in brains of humans should be (X, Y, t). The feature of (t) is that the 2D image varies with time through memory of the brain of the user and then the brain of the user will compare the images, which are at different times, to find the differences between them and consider the image is a 3D image because of the differences. The parameter varies with time maybe the depth of field (equivalent to the Z coordinates), or view angles (or visual angles), or the change of presented angle of an object such as rotation.

When a human sees an object, the left eye and the right eye respectively receive different 2D images (the left-eye image and the right-eye image) of the same object, namely so-called parallax. The images projecting on the retina through the left eye and the right eye are 2D images too. The left-eye image and the right-eye image are superimposed in the brain of a human and the brain will adjust the images at focus point of eyes (the left eye and the right eye) to be consistent with each other. It means that the left-eye image and the right-eye image are consistent with each other at the focus point of eyes by adjustment of the brain. However, away from the focus point, the left-eye image and the right-eye image of the same object are still different. Accordingly, a person feels that the image of the object seen by himself is a 3D image because the eyes adjust the position of the focus point. When the eyes adjust the position of the focus point, the object varies with change of the position of the focus point and the image superimposed by the brain varies with change of the position of the focus point. It means that the 2D image seen by the person varies with time. Although the person sees a 2D image, the 20 image varies with time. Therefore, a 3D image constructed of 2D (X,Y) and time (t) is created in the brain of the person wherein parameter (t) varies with time is the depth of field or the view angle (or visual angle).

Through the above-mentioned interaction between the eyes and the brain of a human, a 3D image constructed of space (2D (X,Y)) and time (t) is created in the brain. According to this principle, the present invention provides a new method for creating a naked-eye 3D effect. In this method, the eyes of a human do not need to adjust the position of the focus point of the eyes. On the contrary, this method directly changes the 2D image at the same position of the focus point of the eyes for simulating variation of the 2D image with time. It means that in the method, the position of the focus point of the eyes is fixed but the 20 image at this position of the focus point of the eyes is varied with time. Therefore, this method can make the brain of a human spontaneously consider that the image seen through the eyes of the human is a 3D image because this method is consistent with the mechanism of creating 3D effect or 3D image through interaction between the eyes and the brain of the human. By this method, the brain of a user will spontaneously consider that the image seen through the eyes of the human is a 3D image, even the image is shown in a common display which cannot provide or show the left-eye image and the right-eye image simultaneously. Therefore, this method can create a 3D effect but it has no need of a display hologram, 3D glasses, or a special optical film coated on a screen of a display. Even a user seeing the image shown in the display with a single eye, the user still can feel a 3D effect or see a 3D image by this method. Therefore, the method of the present invention is different from the traditional superimposition technology of the left-eye image and the right-eye image. The embodiments of the method of the present invention for creating a naked-eye effect will be discussed in detail in conjunction with the drawings as follows:

### Embodiment 1

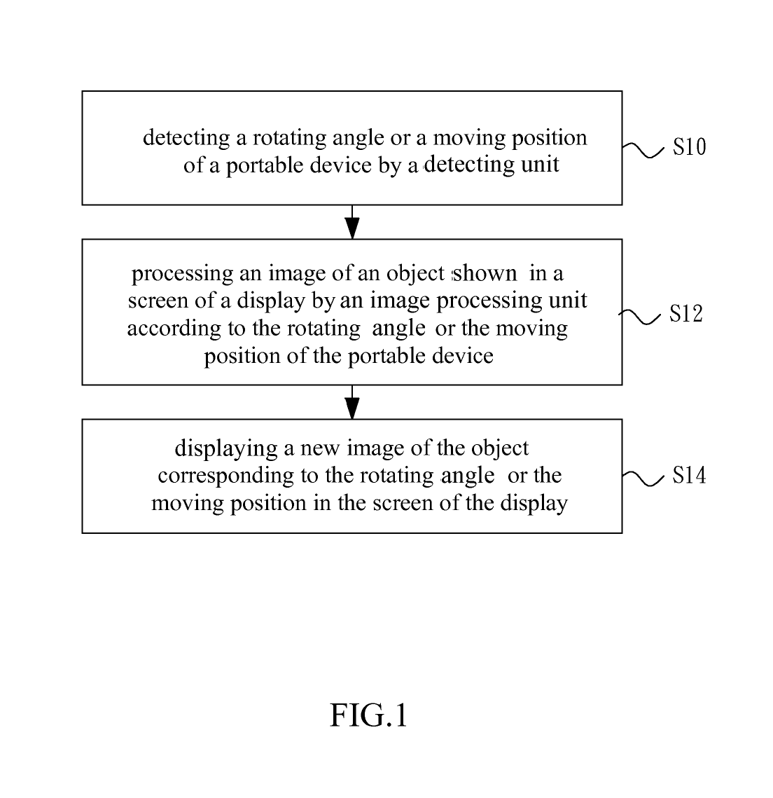

First, the present invention provides a method for creating a naked-eye 3D effect which can be applied to a portable device. The portable device may be a mobile phone, a PDA, a laptop (or notebook PC), a tablet PC, an MP3, or other portable device. FIG. 1 is a flowchart illustrating a method of the present invention applied to a portable device for creating a naked-eye 3D effect in accordance with an embodiment of the present invention. The method has a need to be performed by a system or device including a portable device, a detecting unit for detecting a rotating angle or moving position of the portable device, an image processing unit, and a display. The connection and the communication between the detecting unit and the image processing unit are performed by wire transmission methods or wireless transmission methods. It means that the signals transmission between the detecting unit and the image processing unit is performed by wire transmission methods or wireless transmission methods. The connection and the communication between the image processing unit and the display are performed by wire transmission methods or wireless transmission methods. It means that the signals transmission between the image processing unit and the display is performed by wire transmission methods or wireless transmission methods. Referring to FIG. 1, the method applied to a portable device for creating a naked-eye 3D effect comprises following steps: (1) First, a rotating angle or a moving position of a portable device is detected by a detecting unit (step S10) and then the information of the rotating angle or the moving position of the portable device detected by the detecting unit is transmitted to the image processing unit by wire transmission methods or wireless transmission methods. (2) Next, after the image processing unit receives the information transmitted from the detecting unit, the image processing unit processes an image of an object shown in a screen of a display according to the information transmitted from the detecting unit (the rotating angle or the moving position of a portable device detected by the detecting unit) (step S12). Then, a rotating image or a moving image of the object shown in the screen of the display is created by the image processing unit. It means that a new image of the object is shown in the screen of the display instead of the original image of the object shown in the display wherein the new image is an image of the object after the object rotates an angle or moves a position or distance (depth of field) or the new image is corresponding to the rotating angle or moving position of the object. In other words, the image processing unit creates a new image of the same object shown in the screen of the display, which has a different view angle (or visual angle) or different position (or depth of field) from the original image of the same object shown in the screen of the display, according to the rotating angle or the moving position of the portable device, (3) Finally, after the image processing unit transmits the new image (such as the rotating image or the moving image) of the object, of which the view angle (or visual angle) or the position (or depth of field) has been changed, to the display, the display shows the new image (such as the rotating image or the moving image) of the object in the screen of the display instead of the original image of the object shown in the display (step S14). Therefore, the user can see the images of the object with different view angles (or visual angles) or different positions (or depth of field).

In the above-mentioned method of the present invention applied to a portable device for creating a naked-eye 3D effect, the user always sees or watches the screen of the display, and particularly the user always sees or watches the image of the object shown in the screen of the display. In other words, the position of the focus point of the user's eyes maintains or focuses on the object (or the image of the object) shown in the screen of the display without change or movement. Therefore, when the display shows the images of the object with different view angles (or visual angles) or different positions (or depths of field) according to (or corresponding to) the rotating angle and the moving position (movement) of the portable device, it makes the brain of the user consider that the image of the object, which is shown in the screen of the display and seen by the eyes of the user, varies with time. This method (or mechanism) is consistent with the above-mentioned principle of making the brain of a human spontaneously consider that the image seen through the eyes of the human is a 3D image. Therefore, this method can make the brain of the user spontaneously consider that the image of the object shown on the display is a 3D image. It means that the user will spontaneously consider that the image of the object seen through his eyes is a 3D image. Therefore, a common display can create or provide a naked-eye 3D effect (or image) by this method without the display hologram and the special optical film coated on a screen of a display which can transmit the left-eye image and the right-eye image to the left eye and the right eye of the user respectively. Furthermore, the user can see a 3D image of the object shown in the common display by this method without wearing 3D glasses. Therefore, the naked-eye 3D effect can be achieved and created.

Moreover, in order to make the user see a 3D image when the portable device is not rotated or moved, the screen of the display shows the left eye image and the right eye image by turns with frequency of four times per second or less. When the detecting unit detects that the rotating angle or the moving position (or movement) of the portable device is zero for a predetermined period, for example five seconds or more (but not limited to this), it means that the portable device is not rotated or moved in the predetermined period, the screen of the display automatically shows the images changing from the left eye image to the right eye image (or vice versa) by turns with frequency of four times per second or less for showing images of the same object in the screen of the display with different view angles (or visual angles) or different positions (or depth of field). Therefore, this mechansim is consistent with the above-mentioned principle of making the brain of a human spontaneously consider that the image seen through the eyes of the human is a 3D image and a 3D effect (or image) can be created or provided by this mechanism. The term “left-eye image” means that the image of the object shown in the screen of the display after the object is rotated toward right with a small angle, and it simulates the image which the user sees when the head of the user slightly rotates or swings (or moves) toward left unconsciously. Therefore, the left-eye image shows more (or larger) left portion of the object. The term “right-eye image” means that the image of the object shown in the screen of the display after the object is rotated toward left with a small angle, and it simulates the image which the user sees when the head of the user slightly rotates or swings (or moves) toward right unconsciously. Therefore, the right-eye image shows more (or larger) right portion of the object. Accordingly this mechanism (or method) simulates the images of the (same) object which the user sees when the head of the user slightly rotates or swings (or moves) unconsciously by the display showing the left eye image and the right eye image by turns with frequency of four times per second or less. Therefore, when the portable device is not rotated or moved, the user still can see the image of the (same) object varying with time, such as the images of the (same) object with different view angles (or visual angles), positions, or depth of field. It makes the brain of the user spontaneously consider the image seen by the eyes of the user is a 3D image and the naked-eye 3D effect can be achieved.

In the method of the present invention applied to the portable device for creating a naked-eye 3D effect, the portable device, the detecting unit, the image processing unit, and the display are deposed on or integrated into the same device (or system), or the detecting unit, the image processing unit, and the display are integrated into the portable device. The signal or information transmission between the portable device, the detecting unit, the image processing unit, and the display can be performed by wire transmission methods or wireless transmission methods (or wireless signals). In other embodiment of the present invention, the portable device, the detecting unit, the image processing unit, and the display are four independent devices which separate from each other, and the signal or information transmission between the portable device, the detecting unit, the image processing unit, and the display can be performed by wireless transmission methods (or wireless signals). Or, two of the portable device, the detecting unit, the image processing unit, and the display are deposed on or integrated into the same device (or system), for example the portable device and the detecting unit are deposed on or integrated into the same device (or system), the detecting unit and the image processing unit are deposed on or integrated into the same device (or system), the portable device and the image processing unit are deposed on or integrated into the same device (or system), the image processing unit and the display are deposed on or integrated into the same device (or system), etc. Or, three of the portable device, the detecting unit, the image processing unit, and the display are deposed on or integrated into the same device (or system), for example the portable device, the image processing unit, and the display are deposed on or integrated into the same device (or system). Besides, the portable device and the image processing unit can be deposed on or integrated into the same device (or system), but they can be deposed on different devices. The image processing unit and the display can be deposed on or integrated into the same device (or system), but they can be deposed on different devices. In short, the portable device, the detecting unit, the image processing unit, and the display can be deposed on or integrated into the same device (or system), or they are independent and separated from each other, or three of them can be deposed on or integrated into the same device (or system), or two of them can be deposed on or integrated into the same device (or system). In the embodiment that two of them can be deposed on or integrated into the same device (or system), the other two of them can be independent and separated from each other or they can be deposed on or integrated into the same device (or system). If the portable device, the detecting unit, the image processing unit, and the display are independent and separated from each other, the signal or information transmission between them is performed by wireless transmission methods (or wireless signals).

The detecting unit is a rotating angle detecting unit, a moving position detecting unit, a motion sensor, an image capturing device, a laser, a sensor module, an accelerator, a gyroscope, or other detecting unit which can detect the rotating angle or moving position (or movement) of the portable device.

The image processing unit may be hardware or software (such as an Image processing program). Furthermore, the image processing unit comprises a left-eye image algorithm and a right-eye image algorithm. The left-eye image algorithm is used for calculating and processing the image of the object shown in the screen of the display to create a left-eye image of the object. The left-eye image is the (2D) image of the (same) object after the object rotated toward right with an angle, and the left-eye image shows more (or larger) left portion of the object or all of the left portion of the object. The right-eye image algorithm is used for calculating and processing the image of the object shown in the screen of the display to create a right-eye image of the object. The right-eye image is the (2D) image of the (same) object after the object rotated toward left with an angle, and the right-eye image shows more (or larger) right portion of the object or all of the right portion of the object. In above-mentioned step S12, the left-eye image and the right-eye image are interpolated linearly or nonlinearly by the image processing unit according to the rotating angle or the moving position (or movement) of the portable device for creating the new image of the object corresponding to the rotating angle or the moving position of the object (or the portable device). The new image of the object is a rotating image or moving image of the object after the object is rotated or moved. In other words, the left-eye image and the right-eye image are interpolated linearly or nonlinearly by the image processing unit according to the rotating or moving direction, rotating angle, or moving distance of the portable device for creating the new image of the object which has a different view angle (or visual angle) or position (or depth of field) from the original image of the (same) object.

For illustrating the method of the present invention applied to a portable device for creating a naked-eye 3D effect, we take a mobile phone having a detecting unit, an image processing unit, and a display for an example to illustrate this method. However, the embodiment is provided only to illustrate this method rather than to limit in any way the present invention. The present invention still can be performed by different portable devices or by different configurations of the portable device, the detecting unit, the image processing unit, and the display.

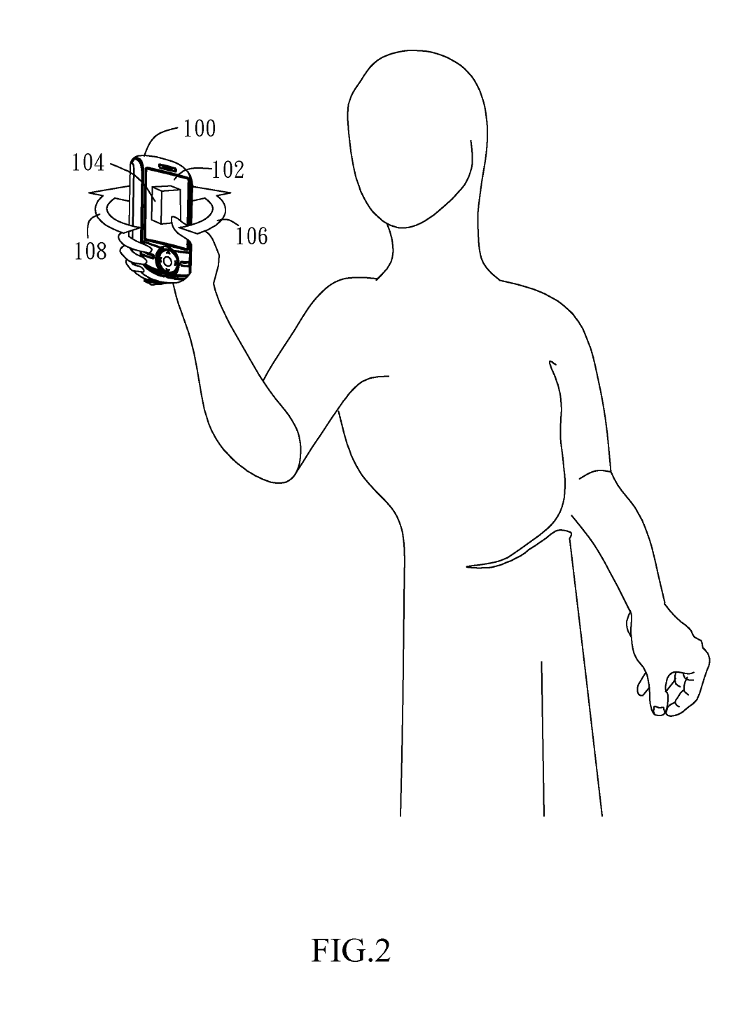

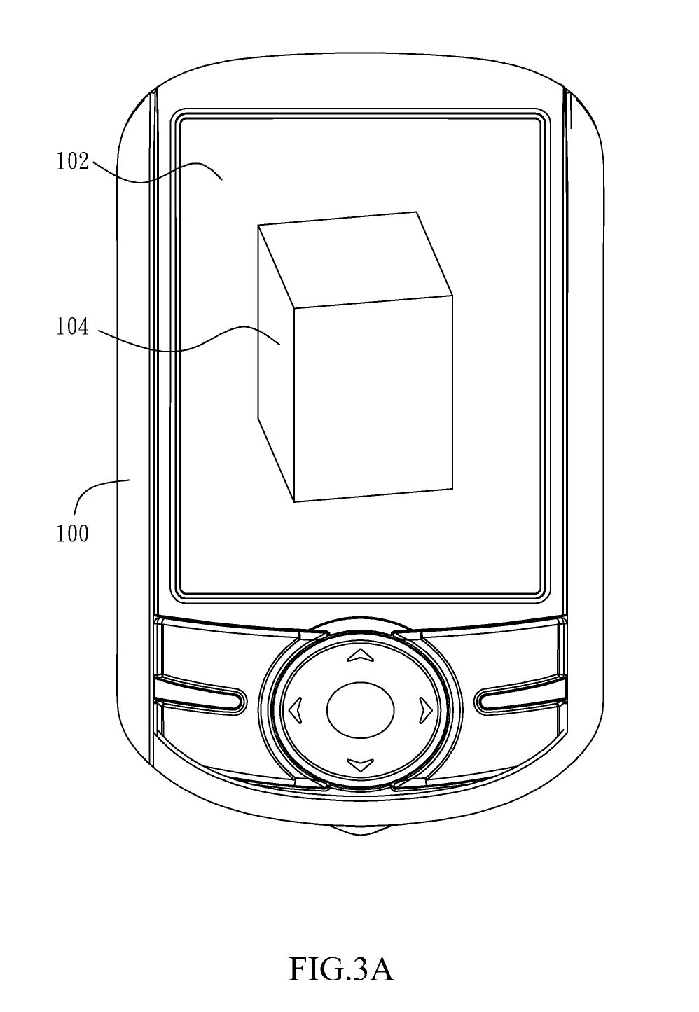

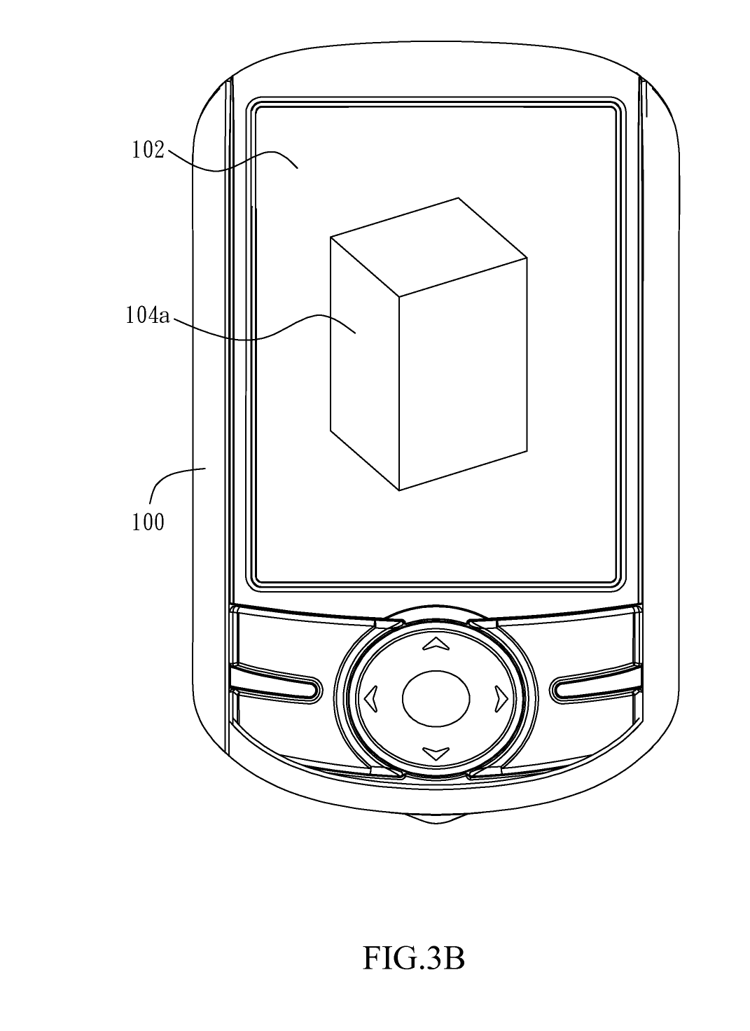

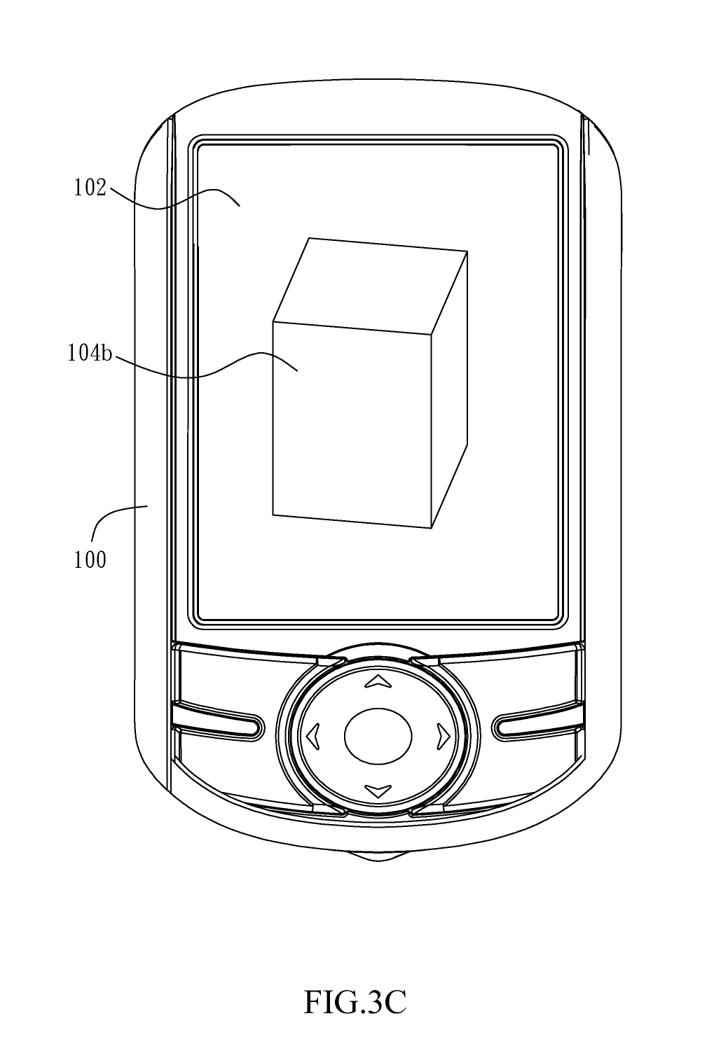

FIG. 2 is a drawing showing how a user uses a mobile phone (or portable device) 100 having a detecting unit, an image processing unit, and a display deposed or integrated therein to perform the method of the present invention for creating a naked-eye 3D effect. Referring to FIG. 2, the user holds the mobile phone 100, and there is a (2D) image 104 of an object shown in the screen 102 of the mobile phone 100 (as FIG. 3A shows). When the user rotates or turns the mobile phone 100 toward right with an angle, it means that the mobile phone 100 is rotated or turned toward right following the direction of the arrow 106 with an angle, the mobile phone 100 detects the rotating angle of the mobile phone 100 by the detecting unit (not shown) (step S10 shown in FIG. 1). Then, the detecting unit transmits the information of the rotating angle of the mobile phone 100 toward right to the image processing unit (not shown) in the mobile phone 100.

After the image processing unit receives the information of the rotating angle of the mobile phone 100 toward right, the image processing unit processes and calculates the original image 104 of the object shown in the screen 102 according to the rotating angle (step S12 shown in FIG. 1). If the mobile phone 100, the image processing unit, or the display has had the data (or information) of the original image 104 of the object (including the left-eye image and the right-eye image of the object) already, the left-eye image and the right-eye image are directly interpolated linearly or nonlinearly by the image processing unit according to the rotating angle of the mobile phone 100 toward right for creating the new image 104a of the object corresponding to the right rotating angle of the mobile phone 100 (as shown in FIG. 3B). The new image 104a is the image of the object after the object is rotated or turned toward right or the new image 104a is the image of the object corresponding to the right rotation of the object. After, as step S14 shows in FIG. 1, the new image 104a of the object is transmitted to the display by wire transmission methods or wireless transmission methods (or wireless signals) instead of the original image 104 in the screen 102 of the display (or the mobile phone 100) (as shown in FIG. 3B). Referring to FIG. 3B, the new image 104a of the object shows more or larger left portion of the object than the original image 104. The larger rotating angle toward right (or the larger right rotating angle detected by the detecting unit) the mobile phone 100 rotates with, the larger left portion of the object the new image 104a created by the image processing unit shows or comprises.

If the mobile phone 100, the image processing unit, or the display does not have the data (or information) of the original image 104 of the object, and particularly does not have the data (or information) of the left-eye image and the right-eye image of the original image 104, the image processing unit calculates and processes the original image 104 by the left-eye image algorithm and the right-eye image algorithm for creating the left-eye image and the right-eye image of the original image 104 respectively. Then, the left-eye image and the right-eye image are interpolated linearly or nonlinearly by the image processing unit according to the rotating angle of the mobile phone 100 toward right for creating the new image 104a of the object corresponding to the right rotating angle of the mobile phone 100 (as shown in FIG. 3B). The new image 104a is the image of the object after the object is rotated or turned toward right or the new image is the image 104a of the object corresponding to the right rotation of the object. After, the new image 104a of the object is transmitted to the display by wire transmission methods or wireless transmission methods (or wireless signals) instead of the original image 104 in the screen 102 of the display (or the mobile phone 100) (as shown in FIG. 3B). By this way, the user can see different images (104 and 104a) of the object shown in the screen 102 with different view angles (or visual angles) at different times. It makes the brain of the user spontaneously consider that the image of the object shown in the screen 102 is a 3D image by way of the image of the object shown in the screen 102 varying with time. Therefore, the naked-eye 3D effect can be achieved.

When the user rotates or turns the mobile phone 100 toward left with an angle, it means that the mobile phone 100 is rotated or turned toward left following the direction of the arrow 108 with an angle, the mobile phone 100 detects the rotating angle of the mobile phone 100 by the detecting unit (not shown) (step S10 shown in FIG. 1). Then, the detecting unit transmits the information of the rotating angle of the mobile phone 100 toward left to the image processing unit (not shown) in the mobile phone 100. After the image processing unit receives the information of the rotating angle of the mobile phone 100 toward left, the image processing unit processes and calculates the original image 104 of the object shown in the screen 102 according to the rotating angle (step S12 shown in FIG. 1). As mentioned above, the left-eye image and the right-eye image are directly interpolated linearly or nonlinearly by the image processing unit, or the image processing unit firstly calculates and processes the original image 104 of the object for creating the left-eye image and the right-eye image of the object and then the left-eye image and the right-eye image are interpolated linearly or nonlinearly by the image processing unit for creating the new image 104b of the object corresponding to the left rotating angle of the mobile phone 100 (as shown in FIG. 3C). The new image 104b is the image of the object after the object is rotated or turned toward left or the new image is the image 104a of the object corresponding to the left rotation of the object. After, as step S14 shows in FIG. 1, the new image 104b of the object is transmitted to the display by wire transmission methods or wireless transmission methods (or wireless signals) instead of the original image 104 in the screen 102 of the display (or the mobile phone 100) (as shown in FIG. 3C). Referring to FIG. 3C, the new image 104b of the object shows more or larger right portion of the object than the original image 104. The larger rotating angle toward left (or the larger left rotating angle detected by the detecting unit) the mobile phone 100 rotates with, the larger right portion of the object the new image 104b created by the image processing unit shows or comprises.

When the user holds the mobile phone 100 for a predetermined period without rotating the mobile phone 100, it means that the detecting unit detects that the mobile phone 100 is not rotated for a predetermined period, for example five seconds or more, the screen 102 (or the display or the mobile phone 100) shows the left-eye image and the right-eye image by turns with frequency of four times per second or less. It means that the image of the object shown in the screen 102 is changed between the left-eye image and the right-eye image by turns with frequency of four times per second or less. For example, the screen 102 shows the image 104a shown in FIG. 3B and the image 104b shown in FIG. 30 by turns with frequency of four times per second or less, but not limited to this. In other embodiment of the present invention, the screen 102 maybe shows the image 104a shown in FIG. 3B and the image 104b shown in FIG. 3C by turns with frequency more than four times per second. By this way, it simulates the images of the (same) object which the user sees when the head of the user slightly rotates or swings (or moves) unconsciously. Therefore, when the portable device (such as the mobile phone 100) is not rotated or moved, the user still can see different images (with different view angles, visual angles, positions, and/or depth of field) of the (same) object at different times. The simulation causes the brain of the user to spontaneously consider that the image of the object shown in the screen 102 is a 3D image of the object. Therefore, the naked-eye 3D effect can be achieved.

### Embodiment 2

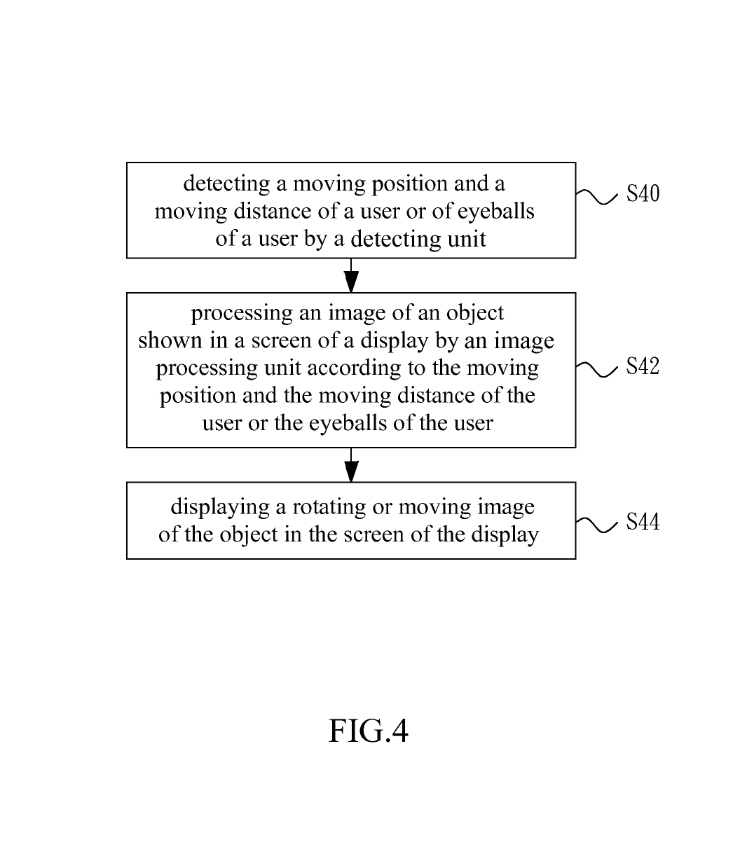

Furthermore, the present invention provides a method for creating a naked-eye 3D effect. FIG. 4 is a flowchart illustrating a method for creating a naked-eye 3D effect in accordance with another embodiment of the present invention. This method has a need to be performed by a device or system having a detecting unit capable of detecting a moving position and a moving distance of a user or a moving position and a moving distance of eyeballs of a user, an image processing unit, and a display. The connection and the communication between the detecting unit and the image processing unit are performed by wire transmission methods or wireless transmission methods. It means that the signals transmission between the detecting unit and the image processing unit is performed by wire transmission methods or wireless transmission methods. The connection and the communication between the image processing unit and the display are performed by wire transmission methods or wireless transmission methods. It means that the signals transmission between the image processing unit and the display is performed by wire transmission methods or wireless transmission methods. Referring to FIG. 4, the method applied to a portable device for creating a naked-eye 3D effect comprises following steps: (1) First, a moving position and a moving distance of a user or a moving position and a moving distance of eyeballs of a user is detected by a detecting unit (step S40) and then the information of the moving position and the moving distance of the user or the information of the moving position and the moving distance of eyeballs of the user detected by the detecting unit is transmitted to the image processing unit by wire transmission methods or wireless transmission methods (or wireless signals). The wireless transmission methods is performed by Bluetooth, infrared, microwave, or other standard wireless signal. (2) Next, after the image processing unit receives the information transmitted from the detecting unit, the image processing unit processes an image of an object shown in a screen of a display according to the information transmitted from the detecting unit (the moving position and the moving distance of the user or the moving position and the moving distance of eyeballs of the user) (step S42). Then, a rotating image or a moving image of the object shown in the screen of the display is created by the image processing unit. It means that a new image of the object is shown in the screen of the display instead of the original image of the object shown in the display wherein the new image is an image of the object after the object rotates an angle or moves a position or distance (depth of field) or the new image is corresponding to the rotating angle or moving position of the object. In other words, the image processing unit creates a new image of the same object shown in the screen of the display, which has a different view angle (or visual angle) or a different position (or depth of field) from the original image of the same object shown in the screen of the display, according to the moving position and the moving distance of the user or the moving position and the moving distance of eyeballs of the user. (3) Finally, after the image processing unit transmits the new image (such as the rotating image or the moving image) of the object, of which the view angle (or visual angle) or the position (or depth of field) has been changed, to the display, the display shows the new image (such as the rotating image or the moving image) of the object in the screen of the display instead of the original image of the object shown in the display (step S44). Therefore, the user can see the images of the object with different view angles (or visual angles) or different positions (or depth of field). Furthermore, in step S40, the user can simulate the moving position and the moving distance of the user (or of eyeballs of the user) by slipping his finger on the display having a touch panel and the detecting unit detects the moving position and the moving distance of the finger. Then, step S42 and step S44 are performed according to the moving position and the moving distance of the finger for providing a naked-eye 3D effect.

In the above-mentioned method of the present invention for creating a naked-eye 3D effect, the user always sees or watches the screen of the display, and particularly the user always sees or watches the image of the object shown in the screen of the display. In other words, it means that the position of the focus point of the user's eyes maintains or focuses on the object (or the image of the object) shown in the screen of the display without change or movement. Therefore, when the display shows the images of the object with different view angles (or visual angles) or different positions (or depths of field) according to (or corresponding to) the moving position and the moving distance of the user or the moving position and the moving distance of eyeballs of the user, the brain of the user considers the image of the object, which is shown in the screen of the display and seen by the eyes of the user, to be varying with time. This method (or mechanism) is consistent with the above-mentioned principle of making the brain of a human spontaneously interpret the image seen through the eyes of the human as a 3D image. Therefore, this method can make the brain of the user spontaneously consider that the image of the object shown on the display is a 3D image. It means that the user will spontaneously consider that the image of the object seen through his eyes is a 3D image. Therefore, a common display can create or provide a naked-eye 3D effect (or image) by this method without the display hologram and the special optical film coated on a screen of a display which can transmit the left-eye image and the right-eye image to the left eye and the right eye of the user respectively. Furthermore, the user can see a 3D image of the object shown in the common display by this method without wearing 3D glasses. Therefore, the naked-eye 3D effect can be achieved and created. In other words, this method simulates that the images of the same object are seen by the user when the user moves toward different sides of the object. The images of the same object have different view angles (or visual angles) or positions (or depth of field) from each other. It makes the user see the image of the object varying with time (or at different times). Therefore, it makes the brain of the user spontaneously consider that the image of the object seen by the user is a 3D image.

Additionally, in order to make the user see a 3D image when the user or eyeballs of the user is not rotated or moved, the screen of the display shows the left eye image and the right eye image by turns with frequency of four times per second or less. When the detecting unit detects that the moving position and the moving distance of the user or of eyeballs of the user are zero for a predetermined period, for example five seconds or more (but not limited to this), it means that the user or eyeballs of the user is not rotated or moved in the predetermined period, the screen of the display automatically shows the left eye image and the right eye image by turns with frequency of four times per second or less for showing images of the same object in the screen of the display with different view angles (or visual angles) or different positions (or depth of field). Therefore, this mechansim is consistent with the above-mentioned principle of making the brain of a human spontaneously consider that the image seen through the eyes of the human is a 3D image and a 3D effect (or image) can be created or provided by this mechanism. The term “left-eye image” and the term “right-eye image” are defined in “EMBODIMENT 1” and they are not mentioned again. This mechanism (or method) simulates the images of the (same) object which the user sees when the head of the user slightly rotates or swings (or moves) unconsciously by the display showing the image varying between the left eye image and the right eye image by turns with frequency of four times per second or less. Therefore, when the user or eyeballs of the user is not rotated or moved, the user still can see the image of the (same) object varying with time, such as the images of the (same) object with different view angles (or visual angles), positions, or depth of field. It makes the brain of the user spontaneously consider the image seen by the eyes of the user is a 3D image and the naked-eye 3D effect can be achieved.

In the method of the present invention for creating a naked-eye 3D effect, the detecting unit, the image processing unit, and the display are deposed on or integrated into the same device (or system), or the detecting unit, the image processing unit, and the display are three independent devices which separate from each other. The signal or information transmission between the detecting unit, the image processing unit, and the display can be performed by wire transmission methods or wireless transmission methods (or wireless signals). Or, two of the detecting unit, the image processing unit, and the display are deposed on or integrated into the same device (or system), for example the image processing unit and the display are deposed on or integrated into the same device (or system), or the detecting unit and the image processing unit are deposed on or integrated into the same device (or system). The image processing unit and the display can be deposed on or integrated into the same device (or system), but they can be deposed on different devices. The detecting unit and the image processing unit are deposed on or integrated into the same device (or system), but they can be deposed on different devices.

The detecting unit is a gravity switch (or gravity sensor), a vibration switch (or vibration sensor), a body sensor, a moving position detecting unit, a motion sensor, an image capturing device, a laser, a sensor module, an accelerator, an infrared sensor (IR sensor), an accelerator, or other sensor or detecting unit which can detect the moving position and the moving distance of the user or the eyeballs of the user. In the past, a computer camera such as a web cam or PC cam is used with software (such as a program) for determining the moving position and the moving distance of the user. However, this method is CPU-intensive. Therefore, in the method of the present invention for creating a naked-eye 3D effect, we utilize other faster method for determining the moving position and the moving distance of the user. The image processing unit may be hardware, software (such as an image processing program), or hardware or device having an image processing program burned therein, for example desktop PC or workstation. Besides, the image processing unit and the display may be deposed on or integrated in a laptop (or notebook PC), tablet PC, or other similar devices. The image processing unit comprises a left-eye image algorithm and a right-eye image algorithm. They are mentioned and detailed before, so they are not mentioned and detailed herein again. In the above-mentioned step S42, the left-eye image and the right-eye image are interpolated linearly or nonlinearly by the image processing unit according to the moving position (or movement) and the moving distance of the user or eyeballs of the user for creating the new image of the object corresponding to the rotating angle or the moving position of the object (or to the moving position (or movement) and the moving distance of the user or eyeballs of the user). In other words, the left-eye image and the right-eye image are interpolated linearly or nonlinearly by the image processing unit according to the moving position (or movement) and the moving distance of the user or eyeballs of the user for creating the new image of the object which has different view angle (or visual angle) or position (or depth of field) from the original image of the (same) object. The interpolation can be linear or nonlinear for a better 3D effect.

For illustrating the method of the present invention for creating a naked-eye 3D effect, we take a system comprising a flat panel display having an image processing unit deposed therein, and a detecting unit for an example to illustrate this method. However, this embodiment is only used to illustrate this method, but it is not used to limit the present invention. The present invention still can be performed by different systems or by different configurations of the detecting unit, the image processing unit, and the flat panel display.

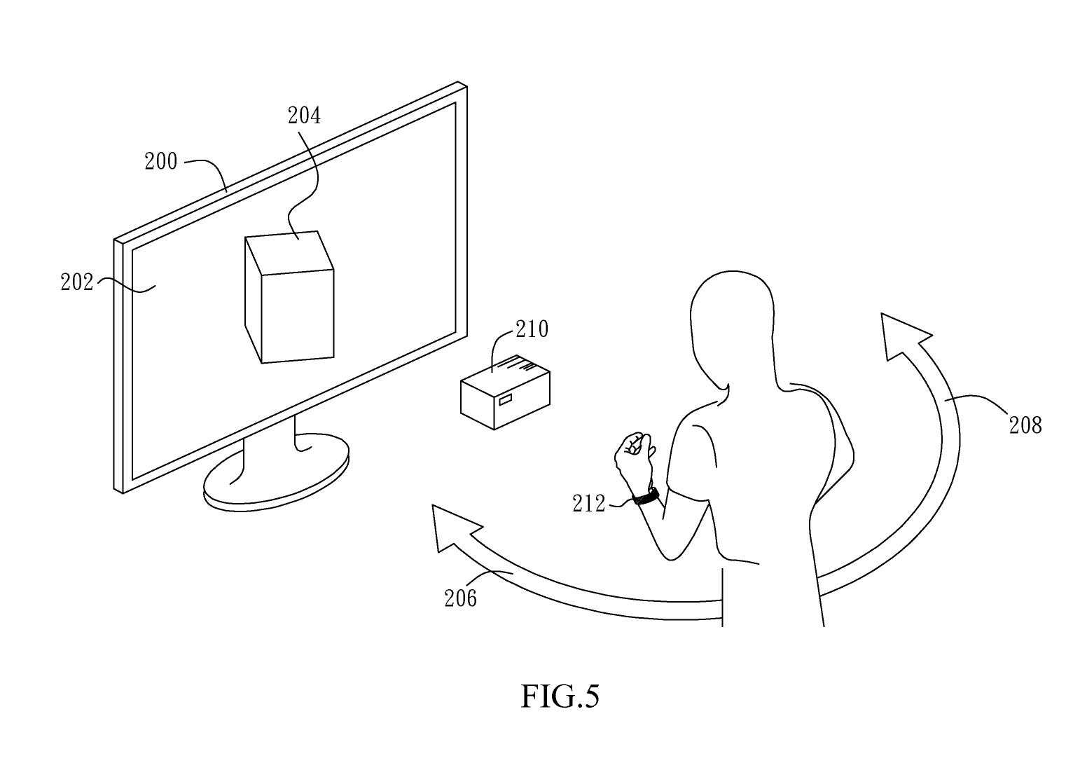

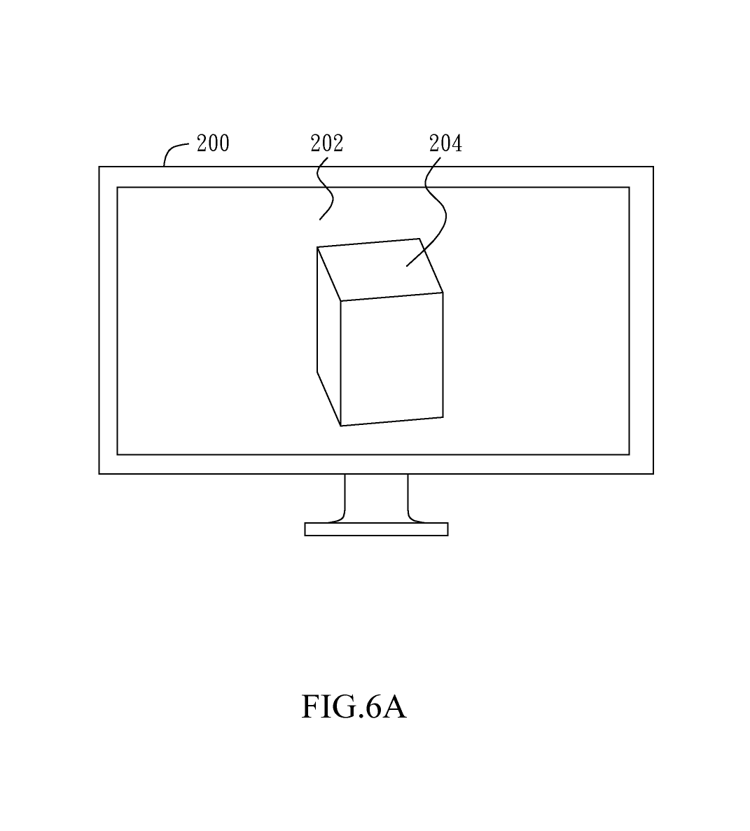

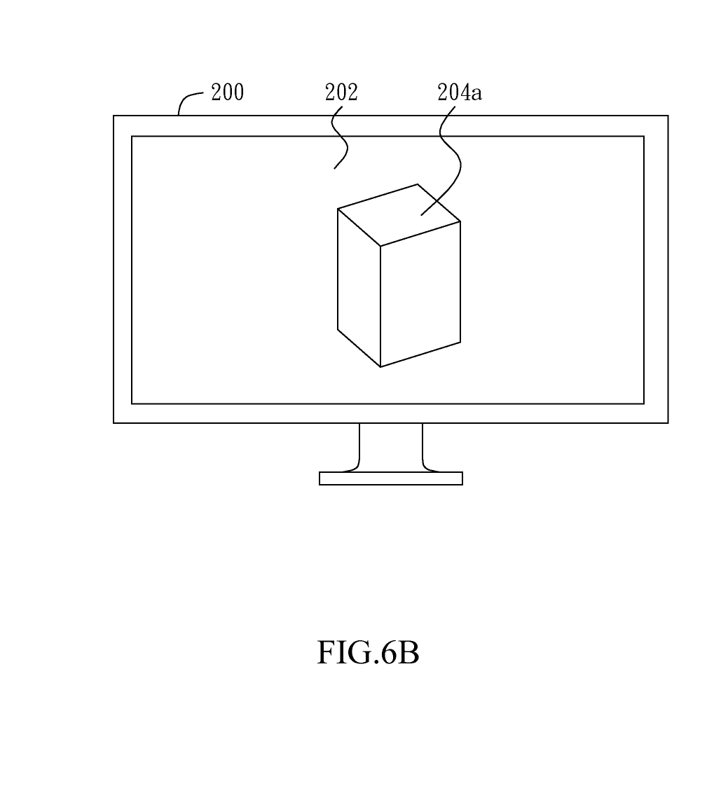

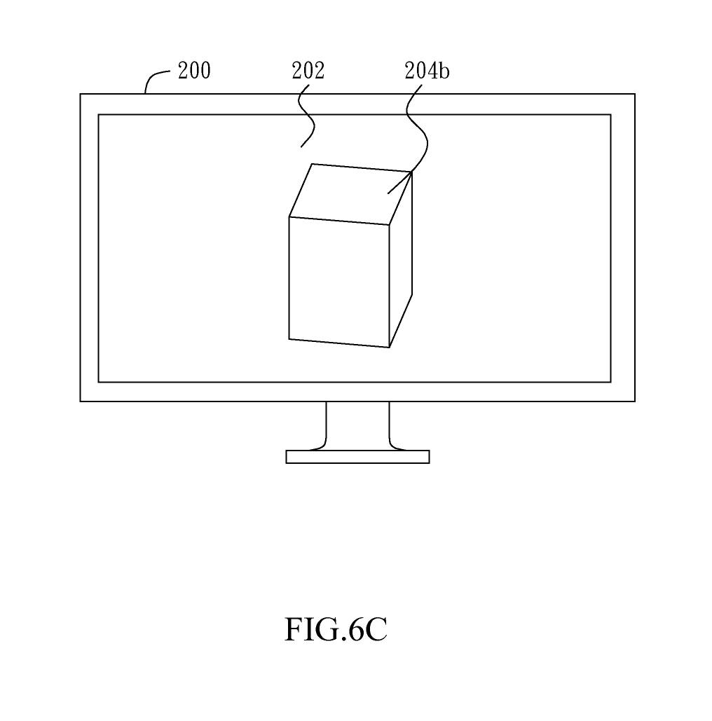

FIG. 5 is a drawing showing how a user uses a system comprising a flat panel display 200 having an image processing unit (not shown) deposed therein and a detecting unit 210 to perform the method of the present invention for creating a naked-eye 3D effect. Referring to FIG. 5, the user faces the screen 202 of the flat panel display 200, and there is a (2D) image 204 of an object shown in the screen 202 of the flat panel display 200 (as FIG. 6A shows). When the user or the user's eyeballs moves toward left with a distance, it means that the user or the user's eyeballs moves toward left following the direction of the arrow 206 with a distance, the detecting unit 210 detects the moving position (or movement) and the moving distance of the user or the user's eyeballs (step S40 shown in FIG. 4). Then, the detecting unit 210 transmits the information of the moving position (or movement) and the moving distance of the user or the user's eyeballs toward left to the image processing unit (not shown) in the flat panel display 200.

After the image processing unit receives the moving position (or movement) and the moving distance of the user or the user's eyeballs toward left, the image processing unit processes and calculates the original image 204 of the object shown in the screen 202 according to the moving position (or movement) and the moving distance of the user or the user's eyeballs (step S42 shown in FIG. 4). If the image processing unit or the flat panel display 200 has had the data (or information) of the original image 204 of the object (including the left-eye image and the right-eye image of the object) already, the left-eye image and the right-eye image are directly interpolated linearly or nonlinearly by the image processing unit according to the moving position (or movement) and the moving distance of the user or the user's eyeballs toward left for creating the new image 204a of the object corresponding to the left movement of the user or the user's eyeballs with a distance (as shown in FIG. 6B). The new image 204a is the image of the object after the object is rotated or turned toward right or the new image 204a is the image of the object corresponding to the right rotation of the object. It simulates the image of the object seen by the user with a left view angle (or visual angle). After, as step S44 shows in FIG. 4, the new image 204a of the object is transmitted to the flat panel display 200 by wire transmission methods or wireless transmission methods (or wireless signals) instead of the original image 204 in the screen 202 of the flat panel display 200 (as shown in FIG. 6B). Referring to FIG. 6B, the new image 204a of the object shows or comprises more or larger left portion of the object than the original image 204. The longer moving distance toward left (or the longer left moving distance detected by the detecting unit 210) the user or the user's eyeballs moves with, the larger left portion of the object the new image 204a created by the image processing unit shows or comprises.

If the image processing unit or the flat panel display 200 does not have the data (or information) of the original image 204 of the object, and particularly does not have the data (or information) of the left-eye image and the right-eye image of the original image 204, the image processing unit calculates and processes the original image 204 by the left-eye image algorithm and the right-eye image algorithm for creating the left-eye image and the right-eye image of the original image 204 respectively. Then, the left-eye image and the right-eye image are interpolated linearly or nonlinearly by the image processing unit according to the moving position and the moving distance of the user or the user's eyeballs toward left for creating the new image 204a of the object corresponding to the left movement of the user or the user's eyeballs with a distance (as shown in FIG. 6B). The new image 204a is the image of the object after the object is rotated or turned toward right or the new image 204a is the image of the object corresponding to the right rotation of the object. After, the new image 204a of the object is transmitted to the flat panel display 200 by wire transmission methods or wireless transmission methods (or wireless signals) instead of the original image 204 in the screen 202 of the flat panel display 200 (as shown in FIG. 6B). By this way, the user can see different images (204 and 204a) of the object shown in the screen 202 with different view angles (or visual angles) at different times. It makes the brain of the user spontaneously consider that the image of the object shown in the screen 202 is a 3D image because the image of the object shown in the screen 102 varies with time. Therefore, the naked-eye 3D effect can be achieved.

When the user or the user's eyeballs moves toward right with a distance, it means that the user or the user's eyeballs moves toward right following the direction of the arrow 208 with a distance, the detecting unit 210 detects the moving position (or movement) and the moving distance of the user or the user's eyeballs (step S40 shown in FIG. 4). Then, the detecting unit 210 transmits the information of the moving position (or movement) and the moving distance of the user or the user's eyeballs toward right to the image processing unit (not shown) in the flat panel display 200. After the image processing unit receives the moving position (or movement) and the moving distance of the user or the user's eyeballs toward right, the image processing unit processes and calculates the original image 204 of the object shown in the screen 202 according to the moving position (or movement) and the moving distance of the user or the user's eyeballs (step S42 shown in FIG. 4). As mentioned above, the left-eye image and the right-eye image are directly interpolated linearly or nonlinearly by the image processing unit, or the image processing unit firstly calculates and processes the original image 204 of the object for creating the left-eye image and the right-eye image of the object and then the left-eye image and the right-eye image are interpolated linearly or nonlinearly by the image processing unit for creating the new image 204b of the object corresponding to the right movement of the user or the user's eyeballs with a distance (as shown in FIG. 6C). The new image 204b is the image of the object after the object is rotated or turned toward left or the new image 204b is the image of the object corresponding to the left rotation of the object. It simulates the image of the object seen by the user with a right view angle (or visual angle). After, as step S44 shows in FIG. 4, the new image 204b of the object is transmitted to the flat panel display 200 by wire transmission methods or wireless transmission methods (or wireless signals) instead of the original image 204 in the screen 202 of the flat panel display 200 (as shown in FIG. 6C). Referring to FIG. 6C, the new image 204b of the object shows or comprises more or larger right portion of the object than the original image 204. The longer moving distance toward right (or the longer right moving distance detected by the detecting unit 210) the user or the user's eyeballs moves with, the larger right portion of the object the new image 204b created by the image processing unit shows or comprises.

When the user or the user's eyeballs does not move for a predetermined period, it means that the detecting unit detects that the user or the user's eyeballs does not move for a predetermined period, for example five seconds or more, the screen 202 of the flat panel display 200 shows the left-eye image and the right-eye image by turns with frequency of four times per second or less. It means that the image of the object shown in the screen 202 of the flat panel display 200 is changed between the left-eye image and the right-eye image by turns with frequency of four times per second or less. For example, the screen 202 of the flat panel display 200 shows the image 204a shown in FIG. 63 and the image 204b shown in FIG. 6C by turns with a frequency of four times per second or less, such being provided to elucidate rather than limit. In another embodiment of the present invention, the screen 202 may show the image 204a shown in FIG. 6B and the image 204b shown in FIG. 60 by turns with frequency more than four times per second. By this way, it simulates the images of the (same) object which the user sees when the head of the user slightly rotates or swings (or moves) unconsciously. Therefore, when the user or the user's eyeballs does not move, the user still can see different images (of different view angle (or visual angle), position, or depth of field) of the (same) object at different times. It makes the brain of the user spontaneously consider that the image of the object shown in the screen 202 is a 3D image of the object. Therefore, the naked-eye 3D effect can be achieved.

In the embodiment shown in FIG. 5, an identifying device 212 is worn on the hand or arm of the user for emitting an identifying signal to the detecting unit 210. The detecting unit 210 can identify the detecting target by this identifying signal (or the identifying device 212), but such is not limited to this. The identifying signal emitted from the identifying device 212 may be a Bluetooth signal, a wireless signal, a microwave signal, an infrared signal, or other standard signals. Of course, it is not necessary to perform the method of the present invention for creating a naked-eye 3D effect with the identifying device 212. On the contrary, the user can determine whether the identifying device is used in the method according to requirements for performing the method of the present invention for creating a naked-eye 3D effect.

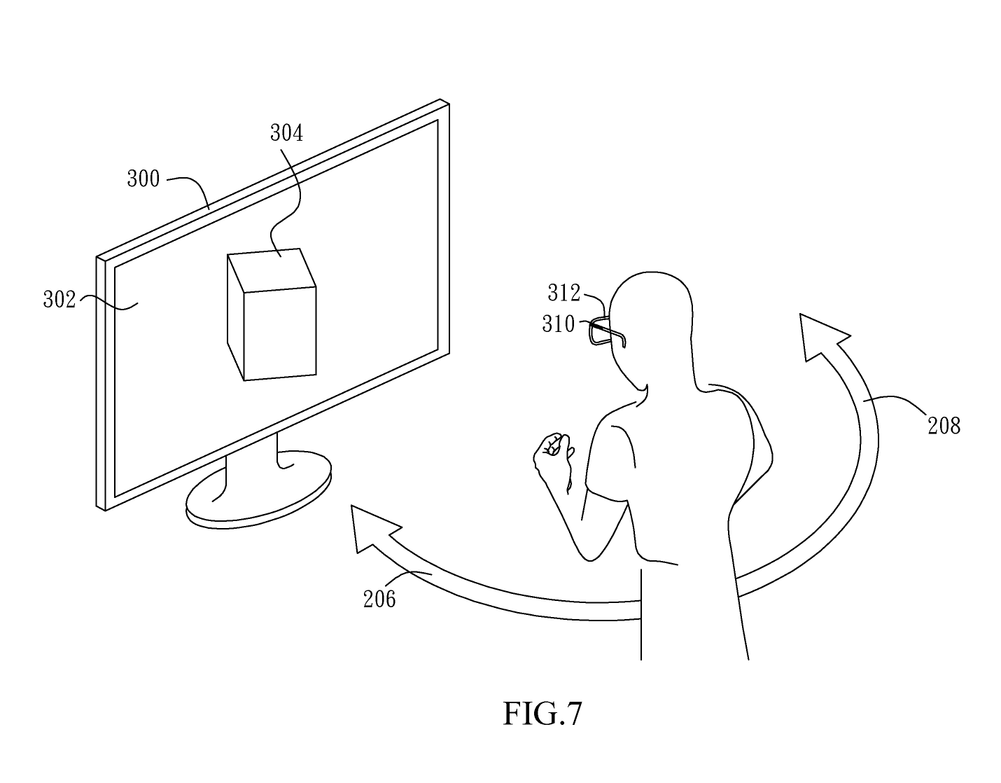

Furthermore, the method of the present invention for creating a naked-eye 3D effect can be performed by a system having a detecting unit, an image processing unit, and a display wherein the detecting unit is worn on the body of the user. Referring to FIG. 7, the method of the present invention for creating a naked-eye 3D effect is performed by a system comprising a flat panel display 300 having an image processing unit (not shown) and a detecting unit 312 deposed on the glasses 310 of the user. The screen 302 of the flat panel display 300 shows an image 304 of an object, too. Although the detecting unit 312 is worn or deposed on the glasses 310 of the user in this embodiment, it is not limited to this. In other embodiments, the detecting unit can be worn or deposed on other portion of the body of the user, for example the detecting unit is worn on an ear of the user as an earphone, or the detecting unit is pinned on the clothes of the user as a pin.

Furthermore, to make the device with better flexibility of using 3D or 2D images, the device (such as the portable device, mobile phone, the display, etc.) illustrated in foregoing embodiments has a button or a soft key to turn off the 3D effect.

Accordingly, a method applied to a portable device for creating a naked-eye 3D effect and a method for creating a naked-eye 3D effect are provided in this invention. In this method, images of the (same) object with different view angles (or visual angles) or positions (or depth of field) are shown with time (or at different times). It makes the brain of the user spontaneously consider that the image seen by the user's eyes is a 3D image. Therefore, the naked-eye 3D effect can be created by this method without a display hologram, 3D glasses, and a special optical film coated on a screen of a display. Accordingly, the cost and difficulty of creating a 3D effect (or image) can be decreased.

What is claimed is:

1. A method for creating a naked-eye effect, comprising:
(1) detecting a rotating angle or a moving position of a portable device by a detecting unit;
(2) processing an image of an object shown in a screen of a display by an image processing unit according to the rotating angle or the moving position of the portable device, and then creating a rotating or moving image of the object shown in the display by the image processing unit according to the rotating angle or the moving position of the portable device; and
(3) displaying the rotating or moving image of the object in the screen of the display instead of the original image of the object shown in the display.

2. The method of claim 1, wherein the detecting unit is a rotating angle detecting unit, a moving position detecting unit, a motion sensor, an image capturing device, a laser, a sensor module, an accelerator or a gyroscope.

3. The method of claim 1, wherein the step (1) comprises an information transmitting step for transmitting information of the rotating angle or the moving position of the portable device detected by the detecting unit to the image processing unit, and then the image processing unit processes the image of the object shown in the screen of the display according to the information.

4. The method of claim 1, wherein in said step (2), when the portable device is turned left or moved toward left, the image processing unit processes the image of the object shown in the screen of the display according to a left rotating angle or a left moving position of the portable device, and then the screen of the display shows the new image of the object corresponding to the left rotating angle or the left moving position of the object.

5. The method of claim 1, wherein in said step (2), when the portable device is turned right or moved toward right, the image processing unit processes the image of the object shown in the screen of the display according to a right rotating angle or a right moving position of the portable device, and then the screen of the display shows the new image of the object corresponding to the right rotating angle or the right moving position of the object.

6. The method of claim 1, wherein the image processing unit comprises a left-eye image algorithm for calculating and processing the image of the object shown in the screen of the display to create a left-eye image of the object, and a right-eye image algorithm for calculating and processing the image of the object shown in the screen of the display to create a right-eye image of the object.

7. The method of claim 6, wherein in said step (2), the left-eye image and the right-eye image are interpolated linearly or nonlinearly by the image processing unit according to the rotating angle or the moving position of the portable device for creating the new image of the object corresponding to the rotating angle or right moving position of the object.

8. The method of claim 1, wherein the detecting unit and the portable device are deposed in the same device or the detecting unit and the portable device are deposed in different devices.

9. The method of claim 1, wherein the detecting unit and the image processing unit are deposed in the same device or the detecting unit and the image processing unit are deposed in different devices.

10. The method of claim 3, wherein in the information transmitting step, the rotating angle or the moving position of the portable device detected by the detecting unit is transmitted to the image processing unit by wireless signals.

11. The method of claim 1, wherein the portable device and the image processing unit are deposed in the same device, or the portable device and the image processing unit are deposed in different devices.

12. The method of claim 1, wherein the image processing unit and the display are deposed in the same device, or the image processing unit and the display are deposed in different devices.

13. The method of claim 1, wherein the portable device, the image processing unit, and the display are deposed in the same device.

14. The method of claim 1, wherein when the detecting unit detects that the rotating angle or the moving position of the portable device is zero for a predetermined period, the screen of the display shows the image varying between the left eye image and the right eye image by turns with frequency of four times per second or less.

15. A method for creating a naked-eye effect, comprising:
(1) detecting a moving position and a moving distance of a user or of eyeballs of a user by a detecting unit;
(2) processing an image of an object shown in a screen of a display by an image processing unit according to the moving position and the moving distance of the user or the eyeballs of the user, and then creating a rotating or moving image of the object shown in the screen of the display by the image processing unit according to the moving position and the moving distance of the user or the eyeballs of the user; and
(3) displaying the rotating or moving image of the object in the screen of the display instead of the original image of the object shown in the display.

16. The method of claim 15, wherein the detecting unit is a gravity switch, a vibration switch, a body sensor, a moving position detecting unit, a motion sensor, an image capturing device, a laser, a sensor module, an infrared sensor, or an accelerator.

17. The method of claim 15, wherein the user can use his finger to slip on the screen of the display for simulating the movement of the user, and a slipping distance or feature of the finger of the user can define a rotating angle of the object shown in the screen of the display.

18. The method of claim 15, wherein the step (1) comprises an information transmitting step for transmitting information of the moving position or the moving distance of a user or eyeballs of a user detected by the detecting unit to the image processing unit, and then the image processing unit processes the image of the object shown in the screen of the display according to the information.

19. The method of claim 18, wherein the information transmitting step is performed by wire transmission methods or wireless transmission methods.

20. The method of claim 19, wherein the wireless transmission methods are performed by Bluetooth, infrared, microwave, or other standard wireless signals.

21. The method of claim 15, wherein the image processing unit comprises a left-eye image algorithm for calculating and processing the image of the object shown in the screen of the display to create a left-eye image of the object, and a right-eye image algorithm for calculating and processing the image of the object shown in the screen of the display to create a right-eye image of the object.

22. The method of claim 21, wherein in said step (2), when the user moves toward left or the eyeballs of the user moves toward left, the image processing unit processes the image of the object shown in the screen of the display according to a left moving position and a left moving distance of the user or the eyeballs of the user, and then the screen of the display shows a left rotating or a left moving image of the object and more portion of the left-eye image is shown in the left rotating or the left moving image of the object.

23. The method of claim 21, wherein in said step (2), when the user moves toward right or the eyeballs of the user moves toward right, the image processing unit processes the image of the object shown in the screen of the display according to a right moving position and a right moving distance of the user or the eyeballs of the user, and then the screen of the display shows a right rotating or a right moving image of the object and more portion of the right-eye image is shown in the right rotating or the right moving image of the object.

24. The method of claim 21, wherein in said step (2), the left-eye image and the right-eye image are interpolated linearly or nonlinearly by the image processing unit according to the moving position and the moving distance of the user or the eyeballs of the user for creating the rotating or moving image of the object.

25. The method of claim 15, wherein the image processing unit and the display are deposed in the same device, or the image processing unit and the display are deposed in different devices.

26. The method of claim 15, wherein the detecting unit and the image processing unit are deposed in the same device, or the detecting unit and the image processing unit are deposed in different devices.

27. The method of claim 21, wherein when the detecting unit detects that the moving position and the moving position of the user or of eyeballs of the user are zero for a predetermined period, the screen of the display shows the image varying between the left eye image and the right eye image by turns with frequency of four times per second or less.

28. The method of claim 15, wherein the detecting unit is worn by the user.
